(19) United States
(12) Patent Application Publication
(10) Pub. No.: US 2005/0112399 A1
(43) Pub. Date: May 26, 2005

(54) Erosion resistant coatings and methods thereof

(76) Inventors: Dennis Michael Gray, Delanson, NY (US); Krishnamurthy Anand, Bangalore (IN); Hans Aunemo, Oslo (NO); Alain Demers, Lachine (CA); Timothy Francis Dumm, Westerville, OH (US); Kanchan Kumari, Bangalore (IN); Warren Arthur Nelson, Clifton Park, NY (US); Olav Rommetveit, Raade (NO); Steven Alfred Tysoe, Ballston Spa, NY (US)

Correspondence Address: CANTOR COLBURN, LLP, 55 GRIFFIN ROAD SOUTH, BLOOMFIELD, CT, 06002, US

(21) Appl. No.: 10/815,258

(22) Filed: Mar. 31, 2004

Related U.S. Application Data
(60) Provisional application No. 60/524,098, filed on Nov. 21, 2003.

(51) Int. Cl. B32B 5/16

(52) U.S. Cl. 428/678; 416/241 R; 428/935; 428/936; 428/323

(57) ABSTRACT

Erosion resistant coating compositions include hard particles in a metal matrix such as nickel-based, cobalt-based and iron-based matrices applied by a plating process for complex geometry or hard to access component surfaces or by thermal spray processes for line of sight applications. These materials and processes are especially suited for providing erosion resistance to hydroelectric turbine components.

### CROSS REFERENCE TO RELATED APPLICATIONS

This application claims the benefits of U.S. Provisional Patent Application Ser. No. 60/524,098 filed Nov. 21, 2003, which is fully incorporated herein by reference.

### BACKGROUND

The present disclosure generally relates to coating methods and compositions for turbine components, and more particularly, to hard particle metal matrix composite coatings. The coatings and methods can be used for turbine components that have complex shapes or have poor access (non-line-of-sight) for standard thermal spray or other line-of-sight-processes. These coatings and processes are especially suitable for hydroelectric turbine components, which exhibit improved silt erosion resistance from the coating.

Components are used in a wide variety of industrial applications under a diverse set of operating conditions. In many cases, the components are provided with coatings that impart various characteristics, such as corrosion resistance, heat resistance, oxidation resistance, wear resistance, and erosion resistance.

Erosion-resistant coatings are frequently used on hydroelectric turbine components, and in particular, the runner and the guide vanes, for Francis-type turbines, and the runners, needles, and seats for Pelton-type turbines, as well as various other components that are prone to silt erosion. Erosion of these components generally occurs by impingement of silt (sand in the water) and particles contained therein (e.g., SiO₂, Al₂O₃, Fe₂O₃, MgO, CaO, clays, volcanic ash, and the like) that are carried by moving bodies of water. Existing base materials for hydroelectric turbine components such as martensitic stainless steels do not have adequate erosion resistance under these conditions. For example, hydroelectric turbine components when exposed to silt in the rivers that exceed 1 kg of silt per cubic meter of water have been found to undergo significant erosion. This problem can be particularly severe in Asia and South America where the silt content during the rainy season can exceed 50 kg of silt per cubic meter of water. The severe erosion that results damages the turbine components causing frequent maintenance related shutdowns, loss of operating efficiencies, and the need to replace various components on a more frequent regular basis than desired.

In order to avoid erosion problems, some power stations are configured to shut down when the silt content reaches a predetermined level to prevent further erosion. Often times, the predetermined level of silt is set at 5 kilograms of silt per cubic meter of water. In addition to shutting down the power stations, various anti-erosion coatings have been developed to mitigate erosion. Such coatings include ceramic coatings of alumina, titania, chromia, and the like; alloys of refractory metals, e.g., WC—CoCr coatings; WC—Co, WC—CoCr+NiCrBSi coatings; carbides; nitrides; borides; or elastomeric coatings. However, the above noted materials and processes used to apply them generally cannot be used to coat all required areas and/or yield coatings that are not totally effective during prolonged exposure to silt.

Current erosion resistant coatings are usually applied by thermal spray techniques, such as air plasma spray (APS), high velocity oxy-fuel (HVOF), and vacuum plasma spray (VPS). The various thermal spray techniques are quite suitable for applying erosion resistant coatings to components when there is sufficient access to the component to enable adequate line-of-sight of the thermal spray gun to the surface of the component to be coated. Control of the gun motion, spray distance, and gun angle to the surface to be coated are variables that must be considered when coating any component. Adequate access and ability to control gun motion speed and pattern over the part, as well as its distance and angle to the part during the coating process are all critical to the quality of the coating and the erosion resistance that results from the coating. These limitations limit the thermal spray process to components that meet these requirements.

Accordingly, there remains a need in the art for improved coating methods and coating compositions that provide effective protection against erosion resistance, such as is required for hydroelectric turbine components. For example, improved coatings and application methods are needed for hydroelectric turbine components having complex shapes, which generally makes access to such regions by line of sight coating processes such as thermal spray very difficult or impossible. For these types of components it would be difficult to manipulate the thermal spray gun while maintaining the required standoff distances and spray angles necessary to produce good coatings.

### BRIEF SUMMARY

Disclosed herein are erosion resistant coatings and processes, which are especially suitable for coating hydroelectric turbine components that are exposed to silt during operation thereof. In one embodiment, the erosion resistant coating comprises a metal matrix; and a plurality of hard particles embedded in the metal matrix, wherein the plurality of hard particles are spaced apart at an average distance equal to or less than 10 microns.

In another embodiment, a hydroelectric turbine component exposed to silt particles during operation thereof comprises an erosion resistant coating comprising a metal matrix; and a plurality of hard particles embedded in the metal matrix, wherein the plurality of hard particles are spaced apart at a distance less than about 10 microns.

An electroless plating process for forming a hard particle coating onto a hydroelectric turbine component comprises dispersing hard particles in a solution; forming a metal ion bath comprising a metal sulfate solution, a hypophosphite solution, and deionized water; heating the bath to a temperature of about 80° C. to about 95° C.; submerging and rotating the hydroelectric turbine component in the bath to plate the hydroelectric turbine component with a coating of the hard particles in a metal matrix; removing the hydroelectric turbine component from the bath; and heating the hydroelectric turbine component in a furnace to a temperature of about 300° C. to about 500° C., wherein the coating has a Mohs hardness greater than 7.

An electroplating process for forming a hard particle composite coating onto a hydroelectric turbine component comprises forming a metal ion bath comprising a metal sulfate solution and deionized water; dispersing hard particles in a metal ion bath; submerging and rotating the hydroelectric turbine component in the bath to plate the hydroelectric turbine component; fixturing the component as the cathode; passing current through the bath and the component to form the hard particle coating; and removing the hydroelectric turbine component from the bath.

A process for forming a hard particle coating onto a hydroturbine component comprises submerging the hydroelectric turbine component into an aqueous plating bath at a temperature of about 80° C. to about 95° C. and for a period of time effective to form a hard particle coating on the hydroelectric turbine component, wherein the plating bath comprises hard particles suspended therein; removing the hydroelectric turbine component from the bath; and heating the hydroelectric turbine component in a furnace to a temperature of about 300° C. to about 500° C.

A process for reducing erosion comprises forming an erosion resistant coating on a surface exposed to silt, wherein the erosion resistant coating comprises a metal matrix, and a plurality of hard particles embedded in the metal matrix, wherein the plurality of hard particles are spaced apart at an average distance less than an average diameter of an impacting silt particle.

The above described and other features are exemplified by the following Figures and detailed description.

### BRIEF DESCRIPTION OF THE DRAWINGS

FIG. 1 is a cross sectional view of an erosion resistant diamond composite coating, with hard diamond particles in a metal matrix; and

FIG. 2 graphically illustrates the erosion rate of various Ni-diamond coatings as a function of volume % and size of diamond.

### DETAILED DESCRIPTION

Disclosed herein are coating compositions and coating methods that provide erosion resistance to components prone to silt erosion while simultaneously maintaining suitable erosion resistance. The erosion resistant coating generally comprises a metal matrix and a plurality of hard particles dispersed in the metal matrix. As used herein, the term “hard particles” generally refers to materials having a Mohs hardness greater than 7, with greater than 8 more preferred, with greater than 9 even more preferred, and equal to 10 most preferred. For example, in one embodiment, the coating composition comprises a metal-diamond composite. As used herein, the term “diamond” is intended to include particles that substantially possess the hardness of the diamond molecular structure without necessarily possessing the ideal molecular structure and is intended to include all forms of diamond particles including powders, flakes, and the like. Diamond has a Mohs hardness equal to 10. The metal-diamond composite comprises diamond particles that are utilized as a second phase in a matrix. The matrix is preferably primarily formed of metal or metal alloys, but which may also include some non-metallic components, e.g., ceramics, intermetallic phases, or intermediate phases. In a preferred embodiment, the matrix surrounding the diamond particulates is a nickel-based, a cobalt-based, or an iron-based alloy.

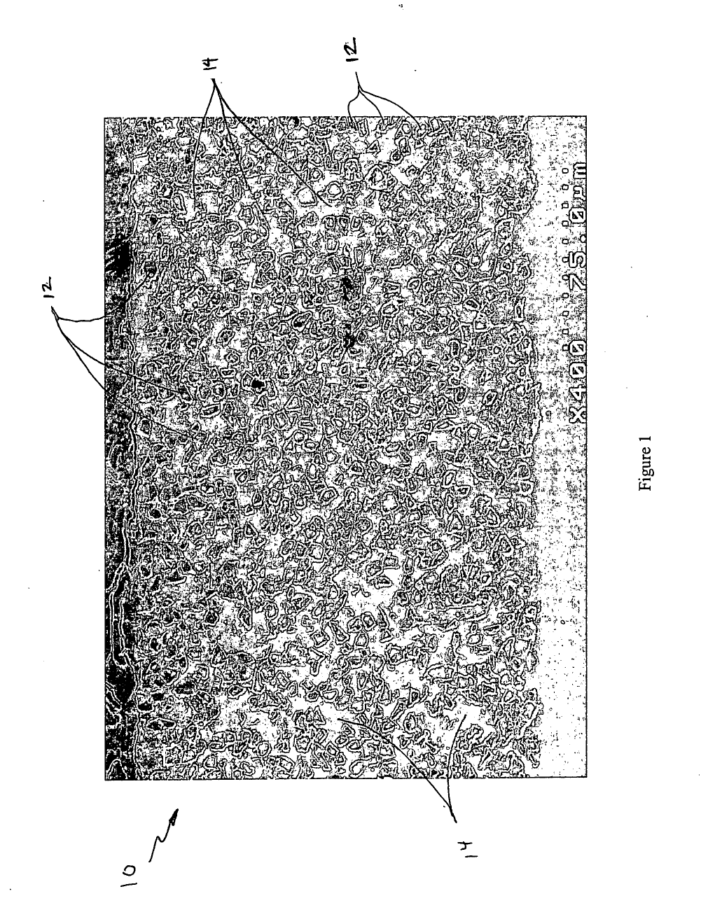

An exemplary hard particle/metal matrix composite structure, generally designated by reference numeral 10, is illustrated in FIG. 1 and is suitable for coating hydroelectric turbine components. The illustrated hard particle/metal matrix composite structure is a metal-diamond composite structure 10 comprising diamond particles 12 having an average diameter of about 5 to 10 microns dispersed in a nickel based alloy matrix 14. The average spacing between diamond particles is about 10 microns.

The composite structure can be applied by a thermal spray process such as HVOF or HVAF, braze processes such as braze tape processes, braze slurry processes, and braze putty processes, electroless and electroplating processes, laser cladding processes, and brush plating processes wherein the electrolyte is pumped through a non-conducting brush as is known in the art. Preferably, the hard particle coating is applied to the component surface by an electroless plating process or an electroplating process. In this manner, components that are generally not suitable for thermal spray processes can be made erosion resistant. That is, for example, components having complex geometries including non-line of sight surfaces can advantageously be made erosion resistant by deposition of the metal-diamond composite using the electroless plating process. Moreover, coating thicknesses in the range of 25-250 microns can be obtained, with higher thicknesses generally desired for erosion resistance.

The electroless plating process generally comprises immersing the desired hydroelectric turbine component in a chemical aqueous salt plating bath using commercially available compositions that result in the deposition of an alloy, such as nickel, onto the component when the component is dipped into the electroless plating baths at the appropriate temperature, e.g., typically about 80 to about 95° C. For example, nickel electroless bath compositions that are commercially available may contain phosphorous or boron that also results in the deposition of the nickel boron and/or phosphorous alloys. The operating parameters and suitable electroless plating compositions are well known to those in the art. Incorporation of hard particles into the electroless coating can be provided by suspending the hard particles and other desired nano-precipitates in a suspension within the plating solution, and maintaining moderate agitation to prevent settling of the particles. Immersing the component into the electroless plating bath containing the suspended hard particles and/or additives ensures complete coating of the component. This process is particularly useful in coating complex shapes where it would be necessary to perform complex robotic motions for a thermal spray gun or for areas of components that a thermal spray gun either can not access or would be difficult to access such as between hydrofoil blades of a 1 meter diameter Francis runner having the blades spaced about 50 millimeters or less apart.

An exemplary electroless plating process suitable for use in the present disclosure employs a nickel-plating bath, which was employed for producing the diamond composite coating of FIG. 1. The exemplary nickel-plating bath includes 6 volume percent nickel sulfate solution, 15 volume percent sodium hypophosphite solution, and 79 volume percent deionized water. For the exemplary nickel-plating bath, the nickel concentration of the bath is preferably maintained at about 5.5 to about 6.3 grams per liter during the coating process. The nickel-plating bath is then heated to about 87° C. A desired amount and size of hard particles, such as diamond, are preferably dispersed in the nickel sulfate solution. The part to be coated is attached to a rotating racking system and fully submerged into the bath. The part is rotated at a defined speed, for example, about 0.5 to about 2 revolutions per minute. Replenishment is periodically performed to maintain the nickel concentration within the preferred range. Adding a 0.6 volume percent solution of nickel sulfate and adding a 0.6 volume percent pH modifier may be employed to effect replenishment. The electroless plating operation is run until the desired thickness is obtained. The exemplary nickel-plating solution exhibited a plating rate of about 20 microns per hour. When the desired thickness has been or is close to being reached, the bath is allowed to plate out. That is, replenishment is discontinued. The plated part is then removed from the bath and dried. The coated part is then placed into a furnace and heated to a temperature of about 300 to about 350° C. for about 1 to about 2 hours.

The electroplating process generally comprises dispersing hard particles into a plating bath solution containing metal ions, e.g., a metal sulfate solution and deionized water. Hard particles are dispersed in the solution. The component is submerged into the solution and rotated. Then, the component is fixed as a cathode and current is passed through the bath to cause plating and the formation of the hard particle coating.

As is generally known to those skilled in the art of electroless plating and electroplating, different bath configurations can be used to plate components of different geometries. For example, a Francis runner may require a tank that is large enough to contain the entire runner so as to allow the entire runner to be coated in one bath. In contrast, Pelton runners may use either a single tank to coat all the runner buckets at once or smaller tanks to coat one or more buckets from a runner. Preferably, the entire component is moved in the bath to ensure that hard particles are uniformly deposited within the metal matrix. However, in situations where the component cannot be moved, the bath can be kept agitated through the motion of paddles or pumps to recirculate the bath onto and into all of the surfaces desired to be coated.

During use of the component in silt impacting environments, the impact crater geometry caused by impact of the silt on the component generally depends on the silt particle size and velocity. For normal impact, the resulting crater is expected to be relatively deeper whereas for impact at shallow angles the crater is elongated and has a width that is proportional to the normal component of velocity. The use of the hard particle composite coating on the component surface minimizes the formation of craters and erosion. It is important to have the distance between particles significantly less then the diameter of the impacting erodent silt to minimize erosion. Most of the silt in the world that causes erosion in hydroelectric turbines has been found to have diameters of about 50 microns to about 250 microns. Although it is expected that the matrix including any amount and size of hard particles within its surface will provide improvement to erosion resistance relative to the metal matrix itself, in a preferred embodiment, the hard particles are uniformly spaced about the surface of the component at an average spacing between adjacent hard particles of less than about 10 micrometers, with an average spacing of less than about 5 micrometers more preferred. In one embodiment, the sizes of the hard particles are preferably about 0.25 microns to about 12 microns in nominal diameter and are spaced apart at less than about 5 to about 10 microns. Preferably, the spacing is less than the average diameter of the silt particle in the particular environment in which the hydroelectric turbine component is exposed. As such, the exposure (i.e., spacing) of the material that forms the binder matrix at the surface is minimized such that the silt particle primarily contacts adjacent diamond particles. Other embodiments include the use of nano-sized hard particle particulates.

The volume fraction of hard particles in the coating is preferably greater than about 25 percent, and with a volume fraction greater than about 35 percent more preferred, wherein the volume fraction is based on the total volume of the metal matrix/hard particle composite coating. By adjusting the hard particle spacing and volume fraction of the metal matrix/hard particle composite coating, erosion caused by impact of silt can be effectively controlled.

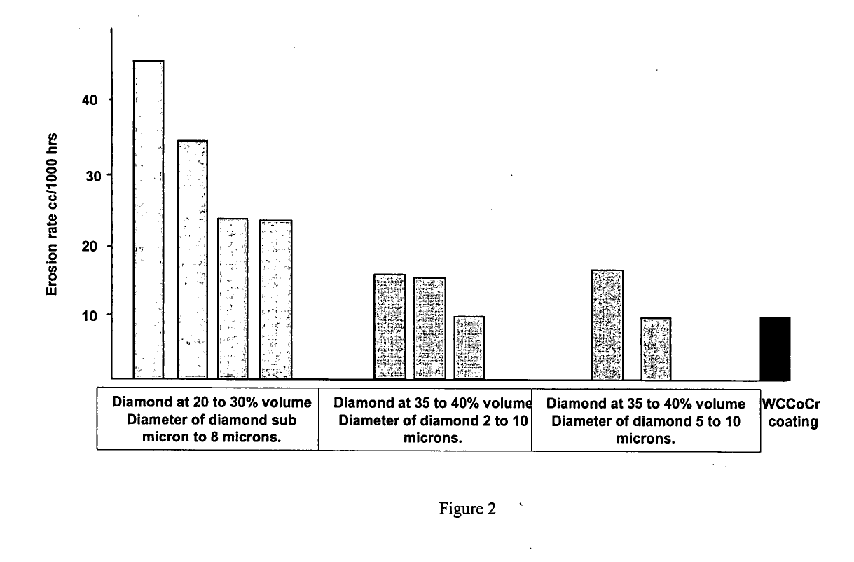

FIG. 2 graphically illustrates the erosion rate of various metal diamond composite coatings relative to a prior art type WCCoCr thermally sprayed coating. Erosion rate improved by incorporating diamonds into a nickel based alloy matrix. Increasing the volume fraction directly increased erosion resistance. Moreover, by controlling the spacing, further gains in erosion resistance can be obtained. It should be noted that the WCCoCr thermally sprayed process is not suitable for complex shapes having non-line of sight surfaces. Thus, the use of the electroless or electroplated hard particle composite coatings provides complex hydroelectric components with erosion resistance comparable to WCCoCr coatings, which is generally not suitable for these types of applications. Thus, the hard particle composite coatings advantageously provide erosion resistance to these complex geometries, erosion resistance that was previously unattainable.

Optionally, the hard particles, e.g., the diamond particles 12 in FIG. 2, are coated with a stabilizing layer that prevents graphitizing and stabilizes the sp3 bonding of the diamond particle for example, as well as facilitates a better bond of the hard particles with nickel. The term sp³ bonding generally refers to each carbon atom being tetrahedrally coordinated with a bond structure that is covalent in nature. Diamond is an example of carbon of sp³ bonding. In this embodiment, the diamond particles 12 are preferably coated in a separate step prior to its introduction into the electroless deposition process. Preferably, nickel, chromium, and/or titanium compounds are used to coat the hard particles to stabilize the particles. Specific examples include, but are not intended to be limited to, nickel compounds that facilitates stabilization of sp³ bond of diamond and deposition of titanium compounds on diamond that enhances bonding of diamond to nickel based matrix. Stabilized hard particles can increase erosion resistance since the stabilized hard particles are less likely to be knocked loose by the impacting silt. Other compounds suitable for stabilizing the sp³ bonding of the diamond particles or improving bonding of the hard particles to the metal matrix will be apparent to those of ordinary skill in the art, in view of this disclosure.

As previously discussed, preferred hard particles have a Mohs hardness greater than 7, with a Mohs hardness greater than or equal to 8 more preferred, with a Mohs hardness greater than or equal to 9 even more preferred, and with a Mohs hardness equal to 10 most preferred. Suitable hard materials include diamond, SiC, B₄C, TiN, TiB₂, Si₃N₄, Al₂O₃, cBN, combinations comprising at least one of the foregoing, and the like. In some embodiments, the hard particles may be co-deposited along with the electroless nickel or cobalt to provide hard erosion resistant composite coatings using the non-line of sight process previously described above or alternatively may utilize the electroplating process described above.

In addition to the hard particles, the metal matrix may further include additives depending on the desired application. For example, nickel-based alloys can be alloyed with additives that contain phosphorous (P) or boron (B). When heat-treated, the additions of P or B can form nano-sized precipitates that further strengthen the metal matrix. As used herein, the term “nano-sized” generally refers to particle sizes of about 1 nanometer to about 100 nanometers. For example, a Ni—P electroless nickel alloy matrix has nickel-phosphide nano-sized precipitates formed therein that impart high hardness properties after heat treatment at 300-400° C. The alloy matrix can also be reinforced with micron to nano-sized particles to further improve hardness properties and wear resistance. For example, nanoparticles of carbides, nitrides, borides, oxides, carbonitrides, oxynitrides or the like can be added for improved hardness and wear resistance properties, wherein the nanoparticle includes at least one metal preferably selected from a group of metals consisting of Al, Si, W, Cr, Ti, Nb, Zr, Hf, Ta and Mo. Moreover, the nanoparticles can reinforce the binder matrix through dislocation disruption. Exemplary nanoparticles include hard oxides such as alumina, carbides such as titanium carbide, borides such as titanium diboride, nitrides such as chromium nitride, and like nanoparticles.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. An erosion resistant coating, comprising:
a metal matrix; and
a plurality of hard particles embedded in the metal matrix, wherein the plurality of hard particles are spaced apart at an average distance equal to or less than 10 microns.

2. The erosion resistant coating of claim 1, wherein the plurality of hard particles have a film of material different from the metal matrix on or about a surface of each one of the plurality of hard particles.

3. The erosion resistant coating of claim 1, wherein the plurality of hard particles are spaced apart at the average distance of less than about 5 microns.

4. The erosion resistant coating of claim 1, wherein the plurality of hard particles and the metal matrix form a substantially continuous film.

5. The erosion resistant coating of claim 1, wherein the plurality of hard particles have an average diameter of about 0.25 microns to about 12 microns.

6. The erosion resistant coating of claim 1, wherein the metal matrix is selected from a group consisting of cobalt based alloy, a nickel based alloy, and an iron based alloy.

7. The erosion resistant coating of claim 2, wherein the film comprises a nickel, chromium, and/or titanium compound at a thickness effective to stabilize the hard particles.

8. The erosion resistant coating of claim 1, wherein the erosion resistant coating is formed by an electroless plating process.

9. The erosion resistant coating of claim 1, wherein the erosion resistant coating is formed by an electroplating process.

10. The erosion resistant coating of claim 1, further comprising an additive dispersed in the erosion resistant coating, wherein the additive is selected from the group consisting of oxides, borides, nitrides, carbides, phosphides, and mixtures thereof.

11. The erosion resistant coating of claim 2, wherein the film is selected from the group consisting of oxides, borides, nitrides, carbides, phosphides, and mixtures thereof.

12. The erosion resistant coating of claim 1, further comprising nanoparticles dispersed in the metal matrix.

13. The erosion resistant coating of claim 1, wherein the hard particles are selected from the group consisting of diamond, SiC, B₄C, TiN, TiB₂, Si₃N₄, Al₂O₃, and cBN.

14. The erosion resistant coating of claim 1, wherein the erosion resistant coating is a substantially continuous film having an average thickness greater than 25 microns.

15. The erosion resistant coating of claim 1, wherein the plurality of hard particles has a Mohs hardness greater than 7.

16. A hydroelectric turbine component having the coating of claim 1.

17. A hydroelectric turbine component exposed to silt particles during operation thereof, the hydroelectric turbine component comprising:
an erosion resistant coating comprising a metal matrix; and a plurality of hard particles embedded in the metal matrix, wherein the plurality of hard particles are spaced apart at an average distance equal to or less than 10 microns.

18. The hydroelectric turbine component of claim 17, wherein the hard particles have a film of a material different from the metal matrix on a surface of each one of the hard particles.

19. The hydroelectric turbine component of claim 17, wherein the plurality of hard particles have an average diameter of about 0.25 microns to about 12 microns.

20. The hydroelectric turbine component of claim 17, wherein the metal matrix is selected from a group consisting of cobalt based alloy, a nickel based alloy, and an iron based alloy.

21. The hydroelectric turbine component of claim 17, further comprising an additive dispersed in the erosion resistant coating, wherein the additive is selected from the group consisting of oxides, borides, nitrides, carbides, phosphides, and mixtures thereof.

22. The hydroelectric turbine component of claim 17, further comprising nanoparticles dispersed in the metal matrix.

23. The hydroelectric turbine component of claim 17, wherein the hard particles of diamond, SiC, B₄C, TiN, TiB₂, Si₃N₄, Al₂O₃, or CBN.

24. The hydroelectric turbine component of claim 17, wherein erosion resistant coating forms a substantially continuous film on the component at an average thickness greater than 25 microns.

25. The hydroelectric turbine component of claim 17, wherein the hard particles have a Mohs hardness greater than 7.

26. An electroless plating process for forming a hard particle coating onto a hydroelectric turbine component, comprising:
dispersing hard particles in a solution;
forming a metal ion bath comprising a metal sulfate solution, a hypophosphite solution, and deionized water;
heating the bath to a temperature of about 80° C. to about 95° C.;
submerging and rotating the hydroelectric turbine component in the bath to plate the hydroelectric turbine component with a coating of the hard particles in a metal matrix;
removing the hydroelectric turbine component from the bath; and
heating the hydroelectric turbine component in a furnace to a temperature of about 300° C. to about 500° C., wherein the coating has a Mohs hardness greater than 7.

27. The electroless plating process of claim 26, wherein the hard particles are spaced apart at an average distance equal to or less than 10 microns.

28. The electroless plating process of claim 26, wherein the metal ion bath has a concentration of metal ions of about 5.5 to about 6.3 grams per liter of bath solution.

29. The electroless plating process of claim 26, further comprising periodically replenishing the bath so as to maintain the metal ion concentration at about 5.5 to about 6.3 grams per liter.

30. The electroless plating process of claim 26, further comprising adding soluble additives containing phosphorous or boron to the metal ion bath.

31. The electroless plating process of claim 26, further comprising forming nanoparticles in the hard particle coating, wherein the nanoparticles comprise carbides, borides, nitrides, or oxides with at least one metal selected from a group of metals consisting of Al, Si, W, Cr, Ti, Nb, Zr, Hf, Ta, and Mo.

32. The electroless plating process of claim 26, wherein the hard particle coating has a volume fraction of hard particles greater than 25 percent.

33. The electroless plating process of claim 26, wherein the hard particles have a nominal diameter of 0.25 microns to 12 microns and are spaced apart in the hard particle coating at a distance equal to or less than about 10 microns.

34. The electroless plating process of claim 26, wherein the coating has an average thickness greater than 25 microns.

35. An electroplating process for forming a hard particle composite coating onto a hydroelectric turbine component, comprising:
forming a metal ion bath comprising a metal sulfate solution and deionized water;
dispersing hard particles in the metal ion bath;
submerging and rotating the hydroelectric turbine component in the bath to plate the hydroelectric turbine component;
fixturing the component as the cathode;
passing current through the bath and the component to form the hard particle coating; and
removing the hydroelectric turbine component from the bath.

36. The process according to claim 35, wherein the hard particles are spaced apart at an average distance equal to or less than 10 microns.

37. The electroplating process of claim 35, wherein the metal ion bath has a concentration of metal ions of about 5.5 to about 6.3 grams per liter of bath solution.

38. The electroplating process of claim 35, further comprising periodically replenishing the bath so as to maintain the metal ion concentration at about 5.5 to about 6.3 grams per liter of bath solution.

39. The electroplating process of claim 35, further comprising adding soluble additives that contain phosphorous or boron to the metal ion bath.

40. The electroplating process of claim 35, further comprising forming nanoparticles in the hard particle coating, wherein the nanoparticles comprise carbides, borides, nitrides, or oxides with at least one metal selected from a group of metals consisting of Al, Si, W, Cr, Ti, Nb, Zr, Hf, Ta, and Mo.

41. The electroplating process of claim 35, wherein the hard particle coating has a volume fraction of hard particles greater than 25 percent.

42. The electroplating process of claim 35, wherein the hard particles have a nominal diameter of 0.25 microns to 12 microns and are spaced apart in the composite hard particle coating at a distance less than 10 microns.

43. The electroplating process of claim 35, wherein the substantially continuous film has an average thickness greater than 25 microns.

44. The electroplating process of claim 35, wherein the hard particles have a Mohs hardness of greater than 7.

45. A process for forming a hard particle coating onto a hydroturbine component, comprising:
submerging the hydroelectric turbine component into an aqueous plating bath at a temperature of about 80° C. to about 95° C. and for a period of time effective to form a hard particle coating on the hydroelectric turbine component, wherein the plating bath comprises hard particles suspended therein;
removing the hydroelectric turbine component from the bath; and
heating the hydroelectric turbine component in a furnace to a temperature of about 300° C. to about 500° C.

46. The process of claim 45, wherein the aqueous plating bath comprises a nickel salt, a cobalt salt, an iron salt, or combinations comprising at least one of the foregoing salts.

47. The process of claim 45, further comprising adding soluble additives that contain phosphorous or boron to the aqueous plating bath.

48. The process of claim 45, further comprising forming nanoparticles in the hard particle coating, wherein the nanoparticles comprise carbides, borides, nitrides, or oxides with at least one metal selected from a group of metals consisting of Al, Si, W, Cr, Ti, Nb, Zr, Hf, Ta, and Mo.

49. The process of claim 45, wherein the hard particle coating has a volume fraction of hard particles greater than 25 percent based on the total volume of the coating.

50. The process of claim 45, wherein the hard particles have a nominal diameter of 0.25 microns to 12 microns and are spaced apart in the hard particle coating at an average distance less than or equal to 10 microns.

51. The process of claim 45, wherein the coating has an average thickness greater than 25 microns.

52. The process of claim 45, wherein the hard particles have a Mohs hardness greater than 7.

53. A process for reducing erosion, comprising
forming an erosion resistant coating on a surface exposed to silt, wherein the erosion resistant coating comprises a metal matrix, and a plurality of hard particles embedded in the metal matrix, wherein the plurality of hard particles are spaced apart at an average distance less than an average diameter of an impacting silt particle.
